(19) United States
(12) Patent Application Publication
(10) Pub. No.: US 2018/0043750 A1
(43) Pub. Date: Feb. 15, 2018

(54) VEHICULAR AIR CONDITIONING DEVICE

(71) Applicant: HANON SYSTEMS, Daejeon (KR)

(72) Inventors: Seung Sik WON, Daejeon (KR); Young In KIM, Daejeon (KR); Boo Yong UM, Daejeon (KR); Jae O JUNG, Daejeon (KR); Seong Seok HAN, Daejeon (KR); Seok KIM, Daejeon (KR); Yong Sik KIM, Daejeon (KR)

(21) Appl. No.: 15/558,215

(22) PCT Filed: Mar. 15, 2016
(86) PCT No.: PCT/KR2016/002569

§ 371 Date: Sep. 14, 2017

(30) Foreign Application Priority Data
Mar. 16, 2015 (KR) 10-2015-0036014
Mar. 15, 2016 (KR) 10-2016-0030832

(51) Int. Cl. B60H 1/00

(52) U.S. Cl. CPC B60H 1/00542; B60H 2001/00092

(57) ABSTRACT

The present invention relates to a vehicular air conditioning device and, more particularly, to a vehicular air conditioning device wherein delimitation walls, which delimit air passages inside an air conditioning case, are formed separately from the air conditioning case and are detachably assembled to left and right cases, respectively, such that the delimitation walls can be fabricated regardless of the mold removing direction during injection molding, making it possible to reduce the thickness and weight; this makes it possible to secure air passages, thereby improving air fluidity, and warm wind supply channels for supplying warm wind to a defrost vent can be integrally formed on the delimitation walls, making any structure for fixing the warm wind supply channels unnecessary; as a result, costs for materials and costs for mold processing can be reduced, and the warm wind supply channels can be freely positioned within the size of the partition walls, thereby facilitating performance improvement.

### TECHNICAL FIELD

The present invention relates to a vehicular air conditioning device, and more particularly, to a vehicular air conditioning device, wherein a partition wall for partitioning an air passage inside an air conditioning case is formed separately from the air conditioning case and is detachably assembled to left and right cases.

### BACKGROUND ART

In general, an air conditioner for a vehicle is a car part, which is installed in a vehicle for the purpose of cooling or heating the interior of the vehicle in the summer season or the winter season or removing frost from a windshield in the rainy season or the winter season to thereby secure a driver's front and rear visual fields. Such an air conditioner typically includes a heating device and a cooling device together, so that it can heat, cool or ventilate the interior of the vehicle through the steps of selectively introducing the indoor air or the outdoor air into the air conditioner, heating or cooling the introduced air, and blowing the heated or cooled air into the vehicle.

According to mounted structures of an air blower unit, an evaporator unit and a heater core unit, such an air conditioner is classified into a three-piece type air conditioner where the air blower unit, the evaporator unit, and the heater core unit are disposed independently, a semi-center type air conditioner where the evaporator unit and the heater core unit are embedded in an air conditioning case and the air blower unit is mounted separately, and a center-mounting type air conditioner where the three units are all embedded in the air conditioning case.

FIG. 1 is a perspective view showing an example of a conventional air conditioner for a vehicle, and FIG. 2 is a sectional view showing a state where partition walls of left and right cases in FIG. 1 are combined.

As shown in the drawings, the conventional air conditioner for a vehicle includes: an air conditioning case 20, which has an air inflow port 27 formed at one side thereof, a plurality of air outflow ports 28, such as a defrost vent 21, a face vent 22 and a floor vent 23, formed at the other side thereof, and an air passage formed inside the air conditioning case 20 to communicate the air outflow ports 28 with the air inflow port 27; an evaporator 2 and a heater core 3 that are mounted on the air passage in order and spaced apart from each other at a predetermined interval; and an air blower (not shown) mounted at the air inflow port 27 of the air conditioning case 20.

Moreover, a temperature adjusting door 25 is mounted between the evaporator 2 and the heater core 3 to adjust temperature, and a plurality of mode doors 24 are respectively mounted at the vents 21, 22 and 23 to carry out various air discharge modes while regulating the degree of opening of the corresponding vents 21, 22 and 23.

In the meantime, the temperature adjusting door 25 is rotatably mounted inside the air conditioning case 20 through a rotary shaft 25a and has a sealing member 25b formed at the edge for sealing.

Furthermore, as shown in FIG. 2, partition walls 40 respectively protrude on the inner faces of left and right cases 20a and 20b, and in this instance, opposite end portions of the partition walls 40 of the left and right cases 20a and 20b are assembled with each other.

The partition walls 40 partition an air passage of the air conditioning case 20 into a predetermined form to form air flow paths.

In the conventional air conditioner, when the air conditioner is turned on, indoor air or outdoor air introduced into the air conditioning case 20 by the air blower is cooled while passing through the evaporator 2, and then, is supplied to the interior of the vehicle through the vents 21, 22 and 23 after being selectively heated by the heater core 3, so that the conventional air conditioner can perform cooling and heating.

However, as shown in FIG. 2, the conventional air conditioner has a problem in that the thickness of the lower ends of the partition walls 40 increases due to the height of the partition walls 40 and the weight of the air conditioner also increases because the partition walls 40 protrude high from the inner faces of the left and right cases 20a and 20b and the sides of the partition walls 40 are sloped for a mold removal gradient.

Furthermore, the conventional air conditioner has a problem in that air fluidity is deteriorated because the air passages are decreased due to an increase of the thickness of the partition walls 40.

### DISCLOSURE

### Technical Problem

Accordingly, the present invention has been made in view of the above-mentioned problems occurring in the prior art, and it is an object of the present invention to provide a vehicular air conditioning device, wherein a partition wall for partitioning an air passage inside an air conditioning case is formed separately from the air conditioning case and is detachably assembled to left and right cases, thereby reducing thickness and weight of the vehicular air conditioning device because the partition wall is fabricated regardless of the mold removing direction during injection molding and improving air fluidity by securing the air passage. It is another object of the present invention to provide a vehicular air conditioning device, wherein warm air supply channels for supplying warm air to a defrost vent are integrally formed on the partition wall, thereby reducing material costs and mold machining costs because additional structure for fixing the warm air supply channels is not needed and facilitating performance improvement by freely positioning the warm air supply channels within the size of the partition wall.

### Technical Solution

To accomplish the above object, according to the present invention, there is provided a vehicular air conditioning device, which includes an air conditioning case being configured by a left case and a right case assembled with each other and having an air passage formed therein and a partition wall for partitioning the air passage inside the air conditioning case into a predetermined form, wherein the partition wall is formed separately from the air conditioning case and is detachably assembled between the left case and the right case.

### Advantageous Effects

As described above, according to embodiments of the present invention, the partition wall for partitioning the air passage inside the air conditioning case is formed separately from the air conditioning case and is detachably assembled to left and right cases, such that the vehicular air conditioning device can reduce its thickness and weight because the partition wall is fabricated regardless of the mold removing direction during injection molding and can improve air fluidity by securing the air passage.

Additionally, according to embodiments of the present invention, the warm air supply channels for supplying warm air to a defrost vent are integrally formed on the partition wall, such that the vehicular air conditioning device can reduce material costs and mold machining costs because additional structure for fixing the warm air supply channels is not needed and can facilitate performance improvement by freely positioning the warm air supply channels within the size of the partition wall.

### DESCRIPTION OF DRAWINGS

FIG. 1 is a perspective view showing an example of a conventional air conditioner for a vehicle.

FIG. 2 is a sectional view showing a state where partition walls of left and right cases of FIG. 1 are assembled with each other.

FIG. 3 is a perspective view showing a state where a right case is separated from a vehicular air conditioning device according to a first preferred embodiment of the present invention.

FIG. 4 is a sectional view of FIG. 3.

FIG. 5 is a partially sectional view showing a state where a partition wall is combined between left and right cases of the vehicular air conditioning device according to the first preferred embodiment of the present invention.

FIG. 6 is a partially sectional view showing another combination structure between the left and right cases and the partition wall in FIG. 5.

FIG. 7 is a perspective view showing a state where a right case is separated from a vehicular air conditioning device according to a second preferred embodiment of the present invention.

FIG. 8 is a sectional view of FIG. 7.

FIG. 9 is a partially sectional view showing a state where a partition wall is combined between left and right cases of the vehicular air conditioning device according to the second preferred embodiment of the present invention.

FIG. 10 is an exploded perspective view of a vehicular air conditioning device according to a third preferred embodiment of the present invention.

FIG. 11 is a partially sectional view showing a state where a partition wall is divisionally assembled between left and right cases and a separator in the vehicular air conditioning device according to the third preferred embodiment of the present invention.

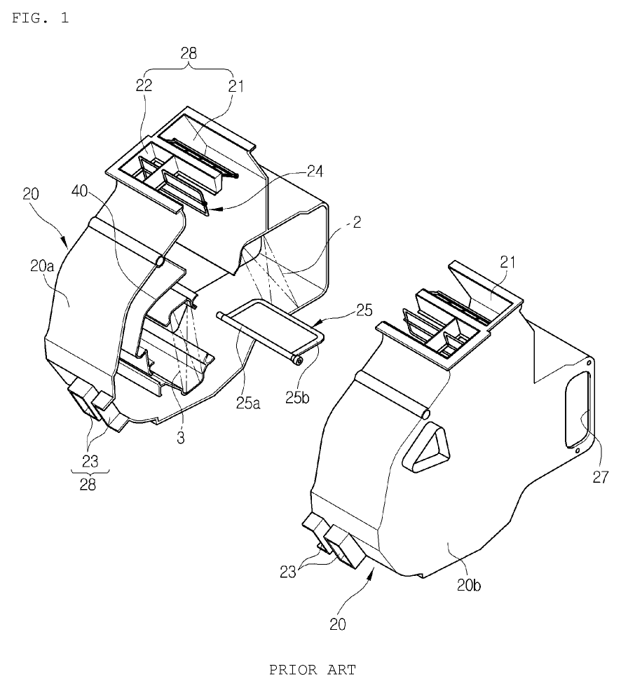

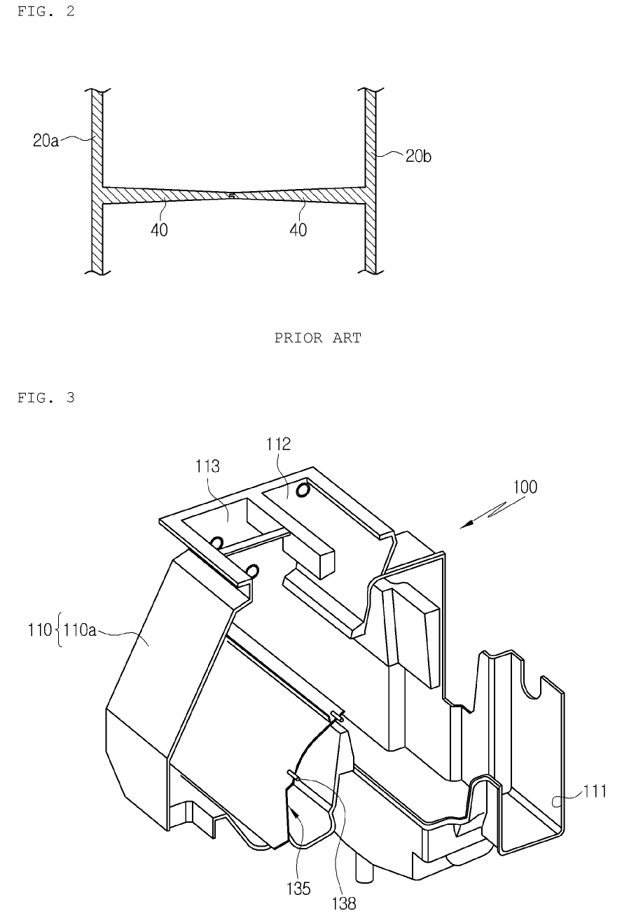

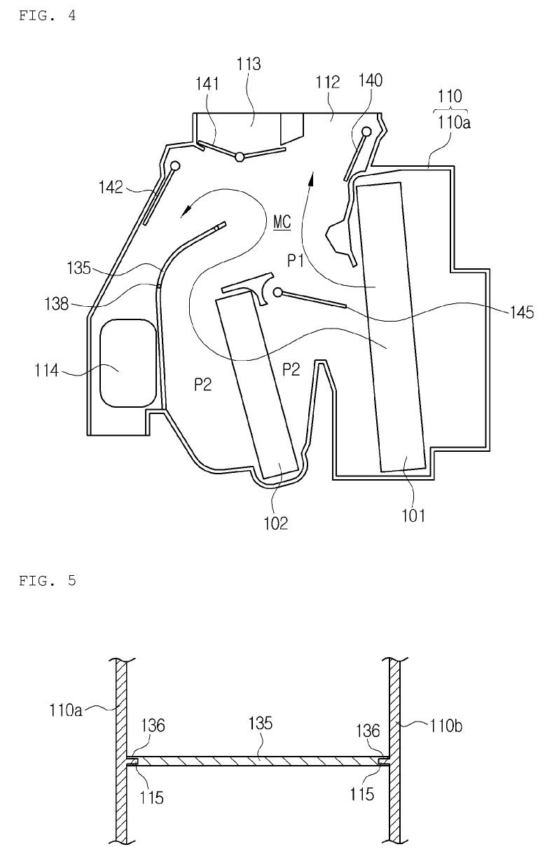

### MODE FOR INVENTION

Reference will be now made in detail to the preferred embodiments of the present invention with reference to the attached drawings.

A vehicular air conditioning device 100 according to an embodiment of the present invention includes: an air conditioning case 110, which has an air inflow port 111 formed at one side (inlet side) thereof for introducing air thereinto, a plurality of air outflow ports, such as a defrost vent 112, a face vent 113 and a floor vent 114, formed at the other side (outlet side) thereof for discharging air to the interior of the vehicle, and an air passage formed inside the air conditioning case 110 to communicate the air outflow ports 28 with the air inflow port 111; an evaporator 101 and a heater core 102 that are mounted on the air passage in order and spaced apart from each other at a predetermined interval; and an air blower (not shown) mounted at the air inflow port 111 of the air conditioning case 110.

The air conditioning case 110 is formed by a left case 110a and a right case 110b assembled with each other.

Moreover, a temperature adjusting door 145 is mounted between the evaporator 101 and the heater core 102 to adjust temperature. The temperature adjusting door 145 is rotatably mounted inside the air conditioning case 110 through a rotary shaft to regulate the degree of opening of a cold air passage P1, which bypasses the heater core 102, and a warm air passage P2, which passes through the heater core 102.

Furthermore, in order to selectively distribute the air, which selectively passes the heater core 102 after passing through the evaporator 101, to ducts (not shown) communicating with specific positions inside a vehicle, a plurality of mode doors 140, 141 and 142 are respectively mounted at the defrost vent 112, the face vent 113 and the floor vent 114 to perform various air discharge modes.

In this instance, the mode doors 140, 141 and 142 are also rotatably mounted inside the air conditioning case 110 through their rotary shafts.

The defrost vent 112 discharges air toward the front window of the vehicle, the face vent 113 discharges air toward the face of a passenger, who is sitting on the front seat, and the floor vent 114 discharges air toward the passenger's feet.

In the meantime, the air blower (not shown) includes an indoor air inlet and an outdoor air inlet formed at the upper part to be opened and closed by an indoor and outdoor air converting door 147 for selectively introducing indoor air and outdoor air, and a blower fan mounted inside the air blower for blowing the air introduced through the indoor air inlet and the outdoor air inlet toward the air conditioning case 110.

As described above, the doors mounted inside the air conditioning case 110, such as the temperature adjusting door 145 and the mode doors 140, 141 and 142, convert a flow direction of the air flowing through the air passages inside the air conditioning case 110.

Additionally, a partition wall 135 is formed on the air passage of the air conditioning case 110 to partition the air passage into a predetermined form.

The partition wall 135 is formed in various shapes on the air passage inside the air conditioning case 110 to partition the air passage, such that the air flowing through the air passage flow along the passage partitioned by the partition wall 135.

For example, the partition wall 135 formed at the rear side of the heater core 102 partitions the warm air passage P2 located in the rear side of the heater core 102 from the floor vent 114. Therefore, the air passing through the heater core 102 moves along the passage partitioned by the partition wall 135, is mixed with cold air in a mixing chamber, and then, flows to the air outflow port opened.

As described above, the passage in which the air flows may be formed in various ways according to the form of the partition wall 135.

Moreover, the partition wall 135 is formed separately from the air conditioning case 110 and may detachably assembled between the left case 110a and the right case 110b.

In other words, conventionally, because the partition wall 135 is formed integrally with the inner face of the left case 110a and the inner face of the right case 110b to protrude long to the central part of the air conditioning case 110, the mold removal gradient (slope) is essentially formed on the side of the partition wall 135.

However, according to embodiments of the present invention, the partition wall 135 is formed separately from the air conditioning case 110 and is detachably assembled to the left and right cases 110a and 110b.

As described above, because the partition wall 135 is formed separately from the air conditioning case 110, the partition wall 135 may be fabricated regardless of the mold removing direction during injection molding. In other words, because there is no need to apply the mold removal gradient to the partition wall 135, the vehicular air conditioning device according to the present invention may reduce thickness and weight of the partition wall 135 and material costs. Moreover, the vehicular air conditioning device according to the present invention may improve air fluidity because securing the air passages inside the air conditioning case due to the reduction in thickness of the partition wall 135.

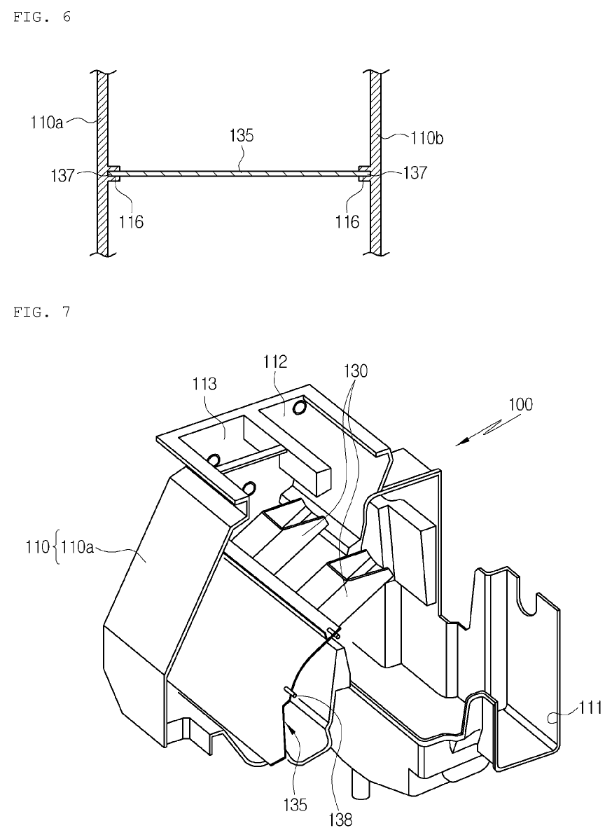

Furthermore, in order to assemble the partition wall 135 and the left and right cases 110a and 110b with each other, as shown in FIGS. 5 and 6, tongue parts 115 and 137 are formed at any one of both end portions of the partition wall 135 and opposite assembled sides of the left and right cases 110a and 110b, and grooves 116 and 136 to which the tongue parts 115 and 137 are inserted are formed at the other one of both end portions of the partition wall 135 and opposite assembled sides of the left and right cases 110a and 110b.

In FIG. 5, the tongue parts 115 are formed on the inner faces of the left and right cases 110a and 110b, and the grooves 136 to which the tongue parts 117 are inserted are formed at both end portions of the partition wall 135.

In FIG. 6, the grooves 116 are formed in the inner faces of the left and right cases 110a and 110b, and the tongue parts 137 which are inserted into the grooves 116 are formed at both end portions of the partition wall 135. Of course, as shown in the drawing, the tongue parts 137 formed at both end portions of the partition wall 135 may be formed in the same thickness as the partition wall 135 or may be formed in different thickness.

Therefore, when the partition wall 135 is assembled between the left and right cases 110a and 110b, the tongue parts 115 and 137 and the grooves 116 and 136 formed on the assembled faces of the left and right cases 110a and 110b and the partition wall 135 are forcedly combined and assembled with each other.

Moreover, a plurality of assembly pins 138 are protrudingly formed at both end portions of the partition wall 135, and a plurality of assembly holes (not shown) to which the assembly pins 138 are forcedly combined are formed on the inner faces of the left and right cases 110a and 110b.

Therefore, in the case that the partition wall 135 is assembled to the left and right cases 110a and 110b, when the assembly pins 138 of the partition wall 135 are first fit to the assembly holes of the left and right cases 110a and 110b, the partition wall 135 may be easily located at the correct position so that assembly can be achieved simply and misassembly is prevented.

Furthermore, the partition wall 135 is mounted to partition the warm air passage P2 of the rear side of the heater core 102 and the floor vent 114.

In this instance, the lower end portion of the partition wall 135 gets in contact with the floor surface of the air conditioning case 110, and the upper end portion is formed to extend toward the mixing chamber MC where cold air and warm air are mixed. Therefore, the warm air passing through the heater core 102 is guided to the partition wall 135 to flow into the mixing chamber MC.

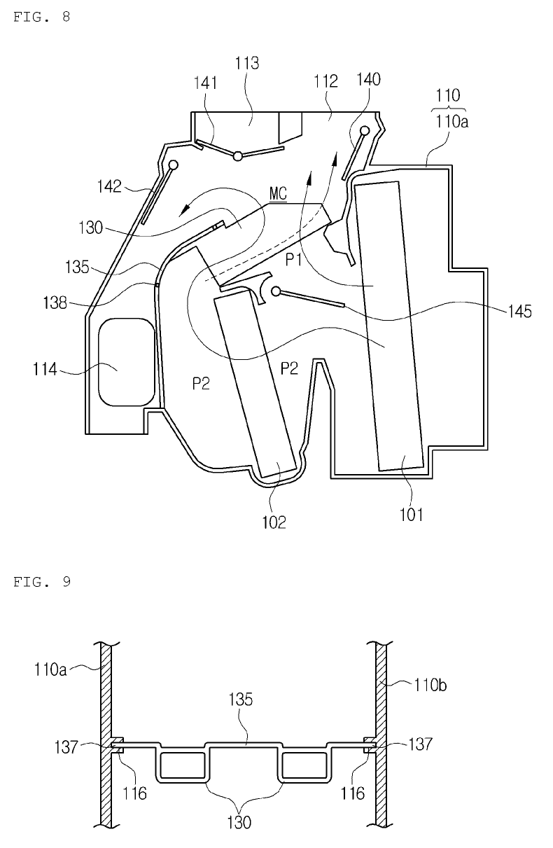

Additionally, in order to forcedly supply the warm air passing through the warm air passage P2 toward the defrost vent 112 according to temperature, performance and requirements of the vehicular air conditioning device 100, warm air supply channels 130 may be mounted. As shown in FIGS. 7 to 9, in a second preferred embodiment of the present invention, the warm air supply channels 130 are formed integrally with the partition wall 135.

That is, because the partition wall 135 is fabricated separately from the air conditioning case 110, the warm air supply channels 130 are formed integrally with the partition wall 135.

As described above, because the warm air supply channels 130 are formed integrally with the partition wall 135, there is no need to have additional structure for fixing the warm air supply channels 130 so that the vehicular air conditioning device according to the second preferred embodiment of the present invention can reduce material costs and mold machining costs. In addition, because the warm air supply channels 130 can be freely located at the correct position within the size of the partition wall 135, the vehicular air conditioning device according to the second preferred embodiment of the present invention can easily improve performance.

Moreover, the warm air supply channels 130 are formed to be located at the mixing chamber MC where the cold air bypassing the heater core 102 and the warm air passing through the heater core 102 inside the air conditioning case 110 are mixed.

Furthermore, the warm air supply channels 130 are made in the form of a tube to be partitioned from the air of the mixing chamber MC, and a pair of the warm air supply channels 130 are formed to be spaced apart from each other at a predetermined interval.

In other words, some of the warm air passing through the warm air passage P2 is mixed with the cold air passing through the cold air passage P1 in the mixing chamber MC, but some of the warm air is not mixed with the cold air but directly flows toward the defrost vent 112 through the tubular warm air supply channels 130, so that warm air is supplied sufficiently and temperature of the warm air does not go down.

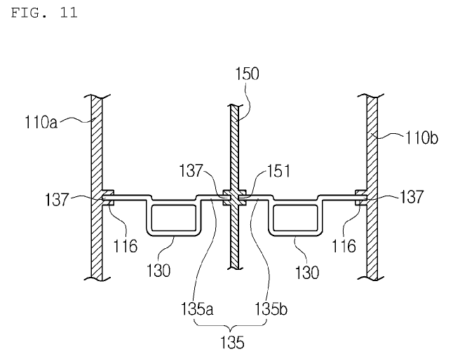

In a third preferred embodiment shown in FIGS. 10 and 11, the partition wall 135 is applied to a structure that a separator 150 is mounted between the left and right cases 110a and 110b in order to independently control temperature of the driver's seat and the passenger's seat inside the vehicle.

Namely, the separator 150 for dividing the air passage inside the air conditioning case 110 into the left and right is mounted between the left case 110a and the right case 110b.

The separator 150 divides the air passage of the downstream side of the evaporator 101 into the left and right inside the air conditioning case 110.

In the meantime, the temperature adjusting door 145 is mounted to be independently controlled at the left and right of the separator 150.

The partition wall 135 includes a left partition wall 135a and a right partition wall 135b which are divided and assembled at the left and right sides of the separator 150.

That is, in the first and second preferred embodiments, the single partition wall 135 is mounted, but in the third preferred embodiment, the partition walls 135 are dividedly assembled at the left and right sides of the separator 150.

Therefore, when the partition wall 135 is formed between the left and right cases 110a and 110b and the separator 150 in an air conditioning device with independent control having the separator 150, the air conditioning device may reduce thickness and weight of the partition wall 135 and material costs.

Moreover, tongue parts 137 are formed at any one of both end portions of the left and right partition walls 135a and 135b and the assembled faces of the left and right cases 110a and 110b and the separator 150, and grooves 116 and 151 to which the tongue parts 137 are respectively inserted are formed at the other one.

In other words, the tongue part 137 is formed at any one of both end portions of the left partition wall 135a and the assembled face of the left case 110a and the separator 150 and the groove 116 or 151 to which the tongue part 137 is inserted is formed at the other one, and the tongue part 137 is formed at any one of both end portions of the right partition wall 135b and the assembled face of the right case 110b and the separator 150 and the groove 116 or 151 to which the tongue part 137 is inserted is formed at the other one.

In FIG. 11, the grooves 116 and 151 are formed at the left and right cases 110a and 110b and the separator 150, and the tongue parts 137 which are respectively inserted into the grooves 116 and 151 are formed at both end portions of the left and right partition walls 135a and 135b.

Of course, as shown in the drawing, the tongue parts 137 formed at both end portions of the left and right partition walls 135a and 135b may be formed in the same thickness as the left and right partition walls 135a and 135b or may be formed in different thickness.

Therefore, when the left and right partition walls 135a and 135b are assembled between the left and right cases 110a and 110b and the separator 150, the tongue parts 137 are respectively assembled to the grooves 116 and 151 of the left and right cases 110a and 110b and the separator 150.

In the meantime, like the first and second preferred embodiment, warm air supply channels 130 are formed integrally with the left and right partition walls 135a and 135b to supply the warm air passing through the warm air passage P2 of the rear side of the heater core 102 to the defrost vent 112. Therefore, there is no need to have additional structure for fixing the warm air supply channels 130 so that the vehicular air conditioning device according to the third preferred embodiment of the present invention can reduce material costs and mold machining costs. In addition, because the warm air supply channels 130 can be freely located at the correct position within the size of the partition wall 135, the vehicular air conditioning device according to the third preferred embodiment of the present invention can easily improve performance.

Hereinafter, the action of the vehicular air conditioning device 100 according to the present invention will be described, and for convenience' sake, the first preferred embodiment as an example will be described.

First, the assembly process will be described.

After the left case 110a (or the right case 110b) is fixed, the partition wall 135 is assembled to the left case 110a.

In this instance, the partition wall 135 is forcedly combined using the tongue parts 115 and 137 and the grooves 116 and 136, which are formed on the assembled faces of the partition wall 135 and the left case 110a.

After that, the right case 110b is forcedly assembled to the other end portion of the partition wall 135 using the tongue parts 115 and 137 and the grooves 116 and 136.

As described above, after the left and right cases 110a and 110b and the partition wall 135 are assembled together, the left and right cases 110a and 110b are fastened by clips (not shown) or screws (not shown), such that the left and right cases 110a and 110b and the partition wall 135 are fixed firmly.

Of course, before the left and right cases 110a and 110b are assembled, various components, such as the doors, are previously located inside the left and right cases 110a and 110b.

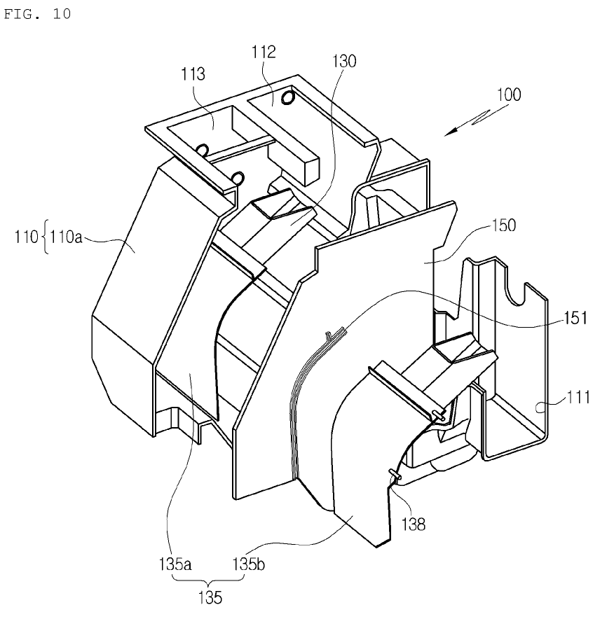

Hereinafter, an air discharge mode of the vehicular air conditioning device 100 will be described. For convenience′ sake, a mixing mode (see FIG. 8) will be described.

First, when air is introduced into the air conditioning case 110 after the air blower is operated, the air is converted into cold air while passing through the evaporator 101.

In this instance, some of the cold air heat-exchanged in the evaporator 101 bypasses the heater core 102 by the temperature adjusting door 145 and flows into the mixing chamber MC. Moreover, some of the cold air is converted into warm air while passing through the heater core 102, flows into the mixing chamber MC along the war air passage P2, and then, is mixed with cold air.

Meanwhile, some of the warm air flowing through the warm air passage P2 is introduced into the warm air supply channel 130, and then, is not mixed with the cold air but directly flows toward the defrost vent 112.

Continuously, some of the air mixed in the mixing chamber MC is discharged toward the window inside the vehicle through the defrost vent 112, and some of the air is discharged toward the passenger's feet inside the vehicle through the floor vent 114.

In the meantime, the mixing mode is only described in this specification, but, other air discharge modes, such as a vent mode, a floor mode, a defrost mode and a by-level mode, may be performed, and detailed descriptions of the air discharge modes will be omitted because such air discharge modes are well-known.

1. A vehicular air conditioning device, which includes:
an air conditioning case being configured by a left case and a right case assembled with each other and having an air passage formed therein; and
a partition wall for partitioning the air passage inside the air conditioning case into a predetermined form,
wherein the partition wall is formed separately from the air conditioning case and is detachably assembled between the left case and the right case.

2. The vehicular air conditioning device according to claim 1, wherein tongue parts are formed at any one of both end portions of the partition wall and assembled sides of the left and right cases, and grooves to which the tongue parts are inserted are formed at the other one.

3. The vehicular air conditioning device according to claim 1, wherein assembly pins are protrudingly formed at both end portions of the partition wall, and assembly holes to which the assembly pins are forcedly combined are formed on the inner faces of the left and right cases.

4. The vehicular air conditioning device according to claim 1, wherein an evaporator and a heater core are mounted inside the air conditioning case to be spaced apart from each other at a predetermined interval,
wherein a defrost vent, a face vent and a floor vent for discharging air to the interior of the vehicle are formed at an outlet side of the air conditioning case, and
wherein the partition wall is mounted to partition a warm air passage of the rear side of the heater core and the floor vent.

5. The vehicular air conditioning device according to claim 4, wherein a warm air supply channel is formed integrally with the partition wall to supply warm air passing through the warm air passage toward the defrost vent.

6. The vehicular air conditioning device according to claim 5, wherein the warm air supply channel is formed to be located in a mixing chamber where cold air bypassing the heater core and warm air passing through the heater core inside the air conditioning case.

7. The vehicular air conditioning device according to claim 6, wherein the warm air supply channel is made in the form of a tube so as to be partitioned from the air of the mixing chamber.

8. The vehicular air conditioning device according to claim 5, wherein a pair of the warm air supply channel are formed to be spaced apart from each other at a predetermined interval.

9. The vehicular air conditioning device according to claim 1, wherein a separator is mounted between the left case and the right case to divide the air passage of the air conditioning case into the left and the right.

10. The vehicular air conditioning device according to claim 9, wherein the partition wall includes a left partition wall and a right partition wall that are dividedly assembled at the left and right sides of the separator.

11. The vehicular air conditioning device according to claim 10, wherein tongue parts are formed at any one of both end portions of the left and right partition walls and assembled sides of the left and right cases and the separator, and grooves to which the tongue parts are inserted are formed at the other one.

12. The vehicular air conditioning device according to claim 10, wherein an evaporator and a heater core are mounted inside the air conditioning case to be spaced apart from each other at a predetermined interval,
wherein a defrost vent, a face vent and a floor vent for discharging air to the interior of the vehicle are formed at an outlet side of the air conditioning case, and
wherein a warm air supply channel is formed integrally with the left and right partition walls to supply the warm air passing through the warm air passage of the rear side of the heater core toward the defrost vent.
